(19) United States
(12) Patent Application Publication
(10) Pub. No.: US 2007/0056758 A1
(43) Pub. Date: Mar. 15, 2007

(54) Rear exhaust type pneumatic tool

(75) Inventor: Lung-Pao Chen, Zhubei City (TW)

Correspondence Address: BIRCH STEWART KOLASCH & BIRCH, PO BOX 747, FALLS CHURCH, VA, 22040-0747, US

(73) Assignee: SUNMATCH INDUSTRIAL CO., LTD.

(21) Appl. No.: 11/209,809

(22) Filed: Aug. 24, 2005

(51) Int. Cl. B23B 45/04

(52) U.S. Cl. 173/169; 173/168

(57) ABSTRACT

A rear exhaust type pneumatic tool includes a curved head, a main body and a pneumatic motor set. The pneumatic motor set includes a rotor, a cylinder installed at the exterior of the rotor, and a front plate and a rear plate respectively installed at the front and rear ends of the cylinder. An air outlet groove disposed on the cylinder, a recession, an indent groove disposed on the cylinder and the surface of an air guide cover connected to the rear plate towards the axial center, and the internal wall of a main body define an exhaust passage. The exhaust passage is extended backward to interconnect with an exhaust hole at the rear end of the main body. After air enters into the cylinder, the driving rotor and vane are rotated, and the air circulated through a rotor is guided through the air outlet groove, exhaust passage, and exhaust hole and discharged from the rear end of the pneumatic tool.

### FIELD OF THE INVENTION

The present invention relates to a pneumatic tool, and more particularly to a rear exhaust type pneumatic tool.

### BACKGROUND OF THE INVENTION

A pneumatic tool is a tool driven by compressed air for its operation, and the tool can be used for grinding an object and other hand tools, and thus the pneumatic tool has the advantages of having power-saving and simple-to-use features. In general, a pneumatic tool comprises a curved head, a pneumatic motor set installed at a distal surface of the curved head, and a main body sheathed onto the external side of the pneumatic motor set, so that a pulling device on the main body can control an air inlet valve to drive compressed air to enter from the air inlet connector into the pneumatic motor set, and drive the tool installed onto the curved head for its operation.

However, the movement of the pneumatic motor set depends on an appropriate installation of air inlet and exhaust devices. The general pneumatic tool adopts a rear exhaust design or a front exhaust design. After the compressed air enters from the air inlet at the rear into the pneumatic motor set, the compressed air is discharged directly from the front passage of the pneumatic motor set. The front exhaust type pneumatic tool of this sort produces a loud noise during its operation. The air discharged from the front end of a front exhaust type pneumatic tool blows the metal dusts, dirt, powders, and bits after grinding or during a grinding process. These dusts fly arbitrarily in the working environment, not only lowering the quality of the working environment, but also affecting the working efficiency or even causing lung diseases to the working staffs due to the flying dusts in the working environment.

### SUMMARY OF THE INVENTION

Therefore, it is a primary objective of the present invention to provide a rear exhaust type pneumatic tool that has a function of discharging air from the rear side of the pneumatic tool.

To achieve the foregoing objective, the rear exhaust type pneumatic tool in accordance with a preferred embodiment of the present invention comprises a curved head, a pneumatic motor set, and a main body; wherein the curved head is pivotally coupled to a tool, and the pneumatic motor set is installed at a distal surface of the curved head and includes a rotor, a cylinder sheathed onto the external side of the rotor, and a front plate and a rear plate disposed separately on the front and rear ends of the cylinder. An end of the rear plate is connected to an air guide cover to define an air inlet passage, and the main body is tightly sheathed onto the external side of the pneumatic motor set. The present invention uses the compressed air passing through the foregoing air inlet passage to drive the cylinder driving rotor and vane to rotate. After the compressed air is circulated by the rotor, the air is guided to the outside from the air outlet groove of the cylinder. With a recession and an indent groove disposed respectively on the cylinder and a surface of the air guide cover towards an axial center, the recession, the indent groove and the internal wall of the main body define an exhaust passage, and the exhaust passage is extended backward to interconnect the exhaust hole at the rear end of the main body. If a user uses compressed air to drive the foregoing tool for its operation, the air enters from the air inlet passage into the cylinder driving rotor and the vane. After the air is circulated by the rotor, the air is discharged through the air outlet grove, the exhaust passage, and the exhaust holes from the rear end of the pneumatic tool, so as to achieve the effect of discharging air without affecting the operating environment.

### BRIEF DESCRIPTION OF THE DRAWINGS

FIG. 1 is a perspective view of a rear exhaust type pneumatic tool according to a preferred embodiment of the present invention;

FIG. 2 is an exploded view of a rear exhaust type pneumatic tool according to a preferred embodiment of the present invention;

FIGS. 3A and 3B are side views of the movements of a rear exhaust type pneumatic tool according to a preferred embodiment of the present invention; and

FIG. 4 is a cross-sectional front view of a rear exhaust type pneumatic tool according to a preferred embodiment of the present invention.

### DETAILED DESCRIPTION OF THE PREFERRED EMBODIMENTS

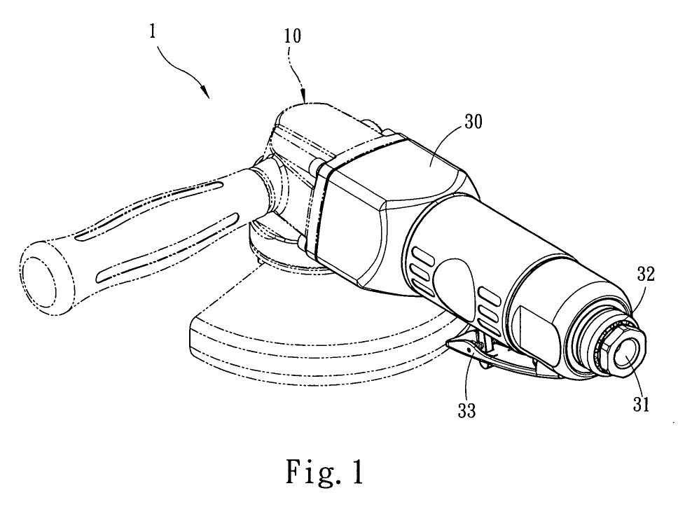

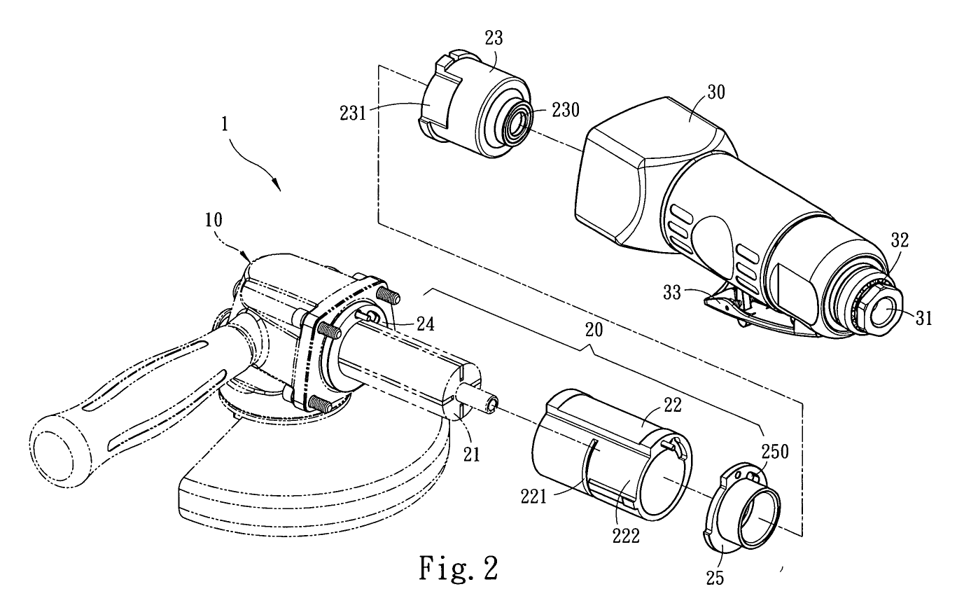

Referring to FIGS. 1 and 2, a rear exhaust type pneumatic tool 1 in accordance with a preferred embodiment of the present invention comprises a curved head 10, a pneumatic motor set 20 and a main body 30 sheathed onto the external side of the pneumatic motor set 20.

The curved head 10 is pivotally coupled to a tool (not shown in the figure), and the tool is a hand tool such as a screwdriver, a wrench, a drill and a saw or a grinding tool including a grinding wheel.

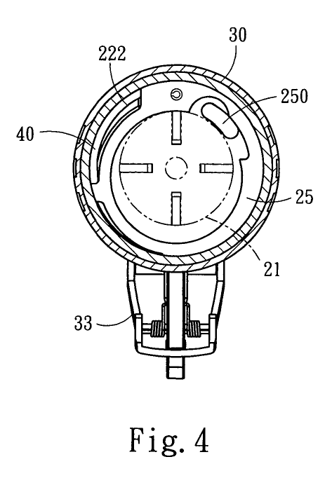

The pneumatic motor set 20 is installed on a distal surface of the curved head 10 and comprise a rotor 21, a cylinder 22, and a front plate 24 and a rear plate 25 separately disposed on the front and rear ends of the cylinder 22, and the cylinder 22 is sheathed onto the external side of the rotor 21, and one end of the rear plate 25 is connected to an air guide cover 23 to form an air inlet passage 250, and the air guide cover 23 includes an air inlet 230 disposed at a rear end for passing the compressed air through the air inlet passage 250 into the cylinder 22 to drive the rotor 21 and vane (not shown in the figure) to rotate, and thus driving the tool pivotally connected to the curved head 10 for its operation. In the preferred embodiment, the main body 30 is tightly sheathed onto the external side of the pneumatic motor set 20, and the cylinder 22 includes an air outlet groove 221, so that the compressed air passing through the air inlet passage 250 into the cylinder 22 to drive the driving rotor 21 and vane to rotate. The air is guided out of the air outlet groove 221 after being circulated by the rotor 21. The preferred embodiment further comprise a recession 222 and an indent groove 231 respectively disposed on the cylinder 22 and a surface of the air guide cover 23 towards an axial center, such that the recession 222, the indent groove 231, and the internal wall of the main body 30 define an exhaust passage 40 (as shown in FIG. 4).

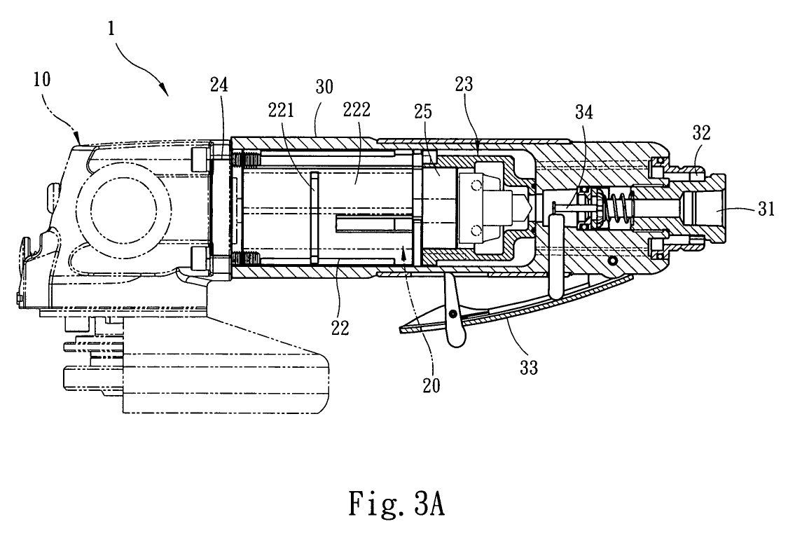

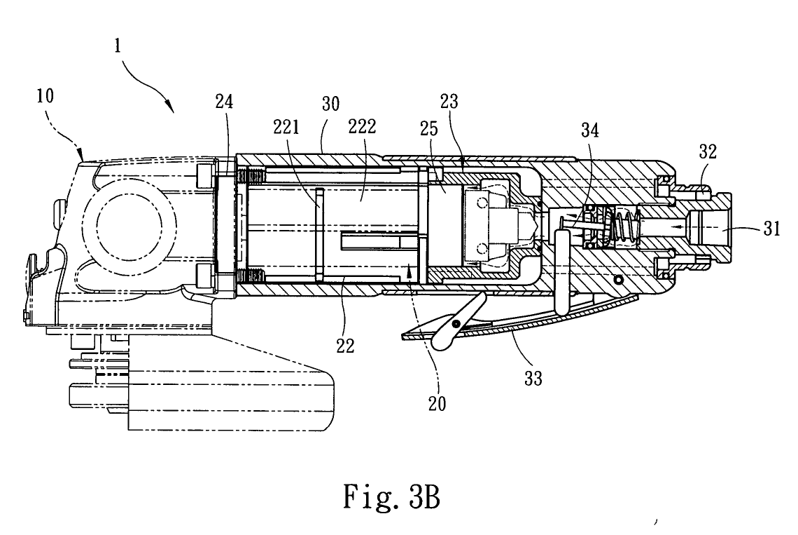

The main body 30 provides a position for holding and operating, and its rear end includes an air inlet connector 31 for connecting to a pressure duct (not shown in the figure) and being interconnected with the air inlet 230 to guide the compressed air into the pneumatic motor set 20. In this embodiment, the air inlet connector 31 includes a plurality of exhaust holes 32 disposed around the air inlet connector 31, and the exhaust passage 40 is extended backward to interconnect with the exhaust hole 32, so that when the air enters into the cylinder 22 through the air inlet passage 250 to drive the driving rotor 21 and vane to rotate, the air is circulated by the rotor 21 and then discharged from the air outlet groove 221, exhaust passage 40, and exhaust hole 32 and out of the rear end of the pneumatic tool 1. Further, the main body 30 includes a pulling device 33 at the bottom of the main body 30 for controlling the movement of the incoming air of the air inlet valve set 34 (as shown in FIG. 3A) and its detailed movement will be described later.

Referring FIGS. 3A, 3B, and 4 for the application of the preferred embodiment, the installation of the air inlet valve set 34 prohibits compressed air from entering from the pressure duct (not shown in the figure) connected to the rear of the air inlet connector 31 into the pneumatic motor set 20 (as shown in FIG. 3A). If a user presses the pulling device 33 to tilt the air inlet valve set 34, then the compressed air enters from the air inlet connector 31 at the rear end through the air inlet passage 250 into the cylinder 22 to drive the internal rotor 21 and vane (not shown in the figure) to rotate, and further drive the tool (not shown in the figure) pivotally coupled to the curved head 10 for its operation (Refer to FIG. 3B). After the air enters into cylinder 22 to drive the driving rotor 21 and vane to rotate, the air is circulated by the rotor 21 and then discharged from the air outlet groove 221 out of the cylinder 22. Since the main body 30 is tightly sheathed onto the external side of the cylinder 22, only the recession 222 and the indent groove 231 respectively disposed on the cylinder 22 and the air guide cover 23 towards an axial center allow the air to flow. Therefore, the discharged air passes backward through the exhaust passage 40 defined by the recession 222, the indent groove 231, and the internal wall of the main body 30, and the air is discharged from the exhaust hole 32 interconnected with the exhaust passage 40 and out of the external side at the rear side of the pneumatic tool 1 (as shown in FIG. 4).

Since the rear exhaust type pneumatic tool 1 of the preferred embodiment discharges air from the rear side, therefore the metal dusts, dirt, powders and bits produced by the grinding process performed at the front side will not fly in the working environment due to the discharged air. Such arrangement will not affect a job and can provide a better operating environment.

In summation of the description above, the rear exhaust type pneumatic tool 1 mainly uses the air inlet groove 221 of the cylinder 22, the recession 222, and the internal walls of the indent groove 231 and the main body 30 to define an exhaust passage 40, so that when a user uses the pneumatic tool 1 to drive a tool (which could be a grinding device or other hand tools) for its operation, the air passes through the air inlet passage 250 into the cylinder 22 to rotate the driving rotor 21 and the vane. After the air is circulated by the rotor 21, the air is discharged through the air outlet groove 221 and the exhaust passage 40 and out of the exhaust hole 32 at the rear end of the pneumatic tool 1. The present invention can achieve the effect of discharging the air from the rear side without affecting the operating environment, and providing a simple structure.

While the invention has been described by means of specific embodiments, numerous modifications and variations could be made thereto by those skilled in the art without departing from the scope and spirit of the invention set forth in the claims.

What is claimed is:

1. A rear exhaust type pneumatic tool, comprising a curved head for pivotally coupling a tool, a pneumatic motor set coupled to a distal end of said curved head, and a main body sheathed into the external side of said pneumatic motor set, and said main body includes an air inlet connector, and compressed air enters from said air inlet connector into said pneumatic motor set to drive said tool to operate, characterized in that said pneumatic motor set comprises a rotor, a cylinder sheathed onto the external side of said rotor, a front plate and a rear plate disposed at the front and rear ends of said cylinder, and one end of said rear plate connected to an air guide cover defines an air inlet passage, and said main body is tightly sheathed onto the external side of said cylinder, and said cylinder includes an air outlet groove, such that compressed air enters into said cylinder from said air inlet passage and is circulated by said rotor and guided out of said air outlet groove, and a recession and an indent groove are disposed respectively on said cylinder and the surface of said air guide cover towards an axial center and the internal wall of said main body define an exhaust passage, and said exhaust passage is extended backward to interconnect with a plurality of exhaust holes at the rear end of said main body, and compressed air drives said rotor to rotate and drives air to discharge from said air outlet groove, said exhaust passage, and said exhaust holes.

2. The rear exhaust type pneumatic tool of claim 1, wherein said exhaust holes are disposed around the periphery of said air inlet connector.
